(19) United States
(12) Patent Application Publication
(10) Pub. No.: US 2012/0294985 A1
(43) Pub. Date: Nov. 22, 2012

(54) CURVED BREAD BUN

(76) Inventors: Sydney M. Claxton, Chippewa Falls, WI (US); Ralph R. Couey, Chippewa Falls, WI (US)

(21) Appl. No.: 13/110,350

(22) Filed: May 18, 2011

(51) Int. Cl. A21D 13/00; A23L 1/317; A23P 1/10; A21D 8/02

(52) U.S. Cl. 426/94; 426/559; 426/138; 426/496; 426/283

(57) ABSTRACT

A baked dough food product includes a body having a free-rise side and an opposite bottom side and first and second opposite ends. The body forms a curved construction. In one example, the baked dough food product is a bun for holding a sausage product that is in a curved shape that generally matches the curved construction of the bun. A method of making a baked dough food product includes providing a dough composition; forming, from the dough composition, an elongate dough body; arranging the dough body on a baking pan and then curving the dough body to form a non-overlapping curved construction; proofing the dough body; and then baking the dough body.

### TECHNICAL FIELD

This disclosure relates generally to baked dough food products, and particularly to bread buns for holding a meat product.

### BACKGROUND

Bread buns for holding a meat product are known in the art. Examples of meat products are sausages, which include hot dogs, frankfurters, bratwurst, and other types of various sausages which can be provided within either a natural casing or an artificial casing. Where natural casings are used, the meat product will generally take on a curved shape when the meat product is cooked. However, bread buns for these types of meat products are typically straight and do not conform to the curved shape of the meat product. Improvements in bread buns are desired.

### SUMMARY

A baked dough food product is provided. The food product includes a body having a free-rise side and a bottom side opposite of the free-rise side. There are first and second opposite ends, with the free-rise side and the bottom side extending between the first and second ends. The body is nonlinear and non-overlapping between the first and second ends to form a curved construction. A straight line is able to extend between the first and second ends without intersecting the body.

In one example implementation, the baked dough food product comprises a bun for holding a sausage product. The sausage product is preferably in a curved shape that generally matches the curved construction of the bun.

In another aspect, a method of making a baked dough food product is provided. The method includes providing a dough composition comprising flour, salt, water, yeast, and sugar. Next, there is a step of forming, from the dough composition, an elongate dough body having a longitudinal axis with opposite first and second ends. Next, there is a step of arranging the dough body on a baking pan and then curving the dough body to form a non-overlapping curved construction between the first and second ends in so that a straight line is able to extend between the first and second ends without intersecting the body. Next, there is a step of proofing the dough body. Next, the dough body is baked to form a baked dough food product.

In another aspect, there is a method of making a food product. The method includes providing a bun having a first curved shape between opposite first and second ends. A straight line is able to extend between the first and second ends without intersecting the bun. The bun has a free-rise side and a bottom side. Next, the bun is sliced to provide an opening to access an interior of the bun between the free-rise side and the bottom side. Next, a sausage product having a second curved shape is oriented through the opening of the bun and into the interior of the bun.

### BRIEF DESCRIPTION OF THE DRAWINGS

FIG. 1 shows a perspective view of a first embodiment of a curved bread bun.

FIG. 2. shows a method for making the curved bread bun shown in FIG. 1.

FIG. 3. shows a schematic top view of a dough composition used to make the curved bread bun shown in FIG. 1.

FIG. 4 shows a schematic end view of the dough composition shown in FIG. 3

FIG. 5 shows a schematic top view of the curved bread bun shown in FIG. 1.

FIG. 6 shows a schematic end view of the curved bread bun shown in FIG. 5.

FIG. 7 shows a schematic top view of a plurality of curved bread buns shown in FIG. 5 arranged on a first embodiment of a baking pan.

FIG. 8 shows a schematic top view of a second embodiment of baking pans.

FIG. 9 shows a schematic front view of the baking pans shown in FIG. 8.

FIG. 10 is a perspective view of the curved bread bun of FIG. 1 holding a sausage.

### DETAILED DESCRIPTION

In general, a curved or arch-shaped bun is provided to accommodate a curved or arch-shaped meat product, such as a sausage product. The curved sausage product can be any type of sausage, which includes hot dogs, wieners, frankfurters, bratwurst, polish sausages, and vegetarian meat substitutes, such as soy-based products. In general, these sausage products have a curved or arcuate shape, which typically results from being provided in a natural casing. In the past, when a typical hot dog bun is used to hold a curved sausage, the bun does not fit the sausage, and the sausage will extend out of the sliced opening of the bun. This application solves that problem by providing a bun having a curved construction that accommodates the curved shape of meat products (such as sausage products) that have a curved shape.

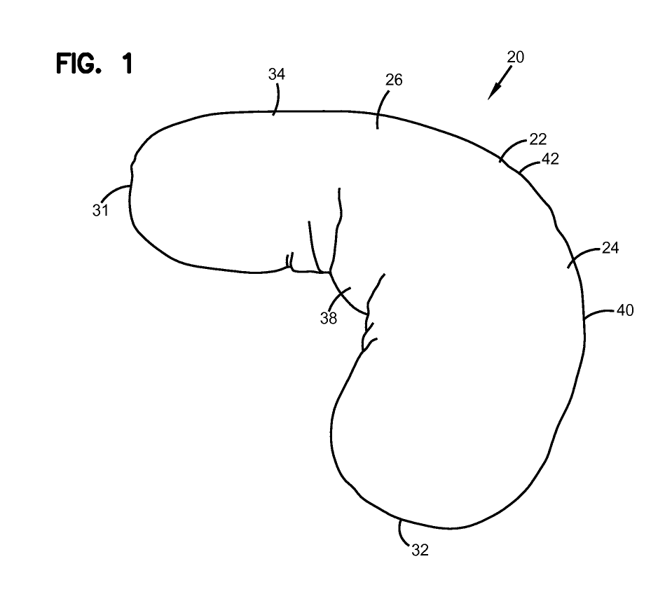

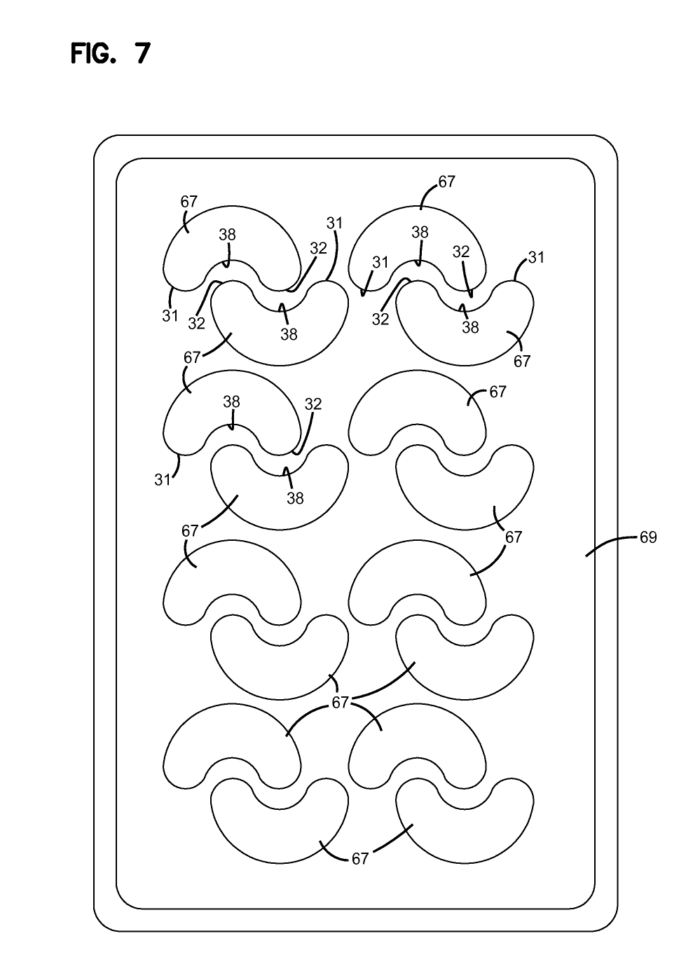

FIG. 1 shows a perspective view of one embodiment of a baked dough food product made in accordance with principals of this disclosure. In FIG. 1, a baked dough food product is shown generally at 20. The baked dough food product 20 typically comprises a bun 22. The embodiment shown, the baked dough food product 20 includes a body 24 having a free-rise side 26 and a bottom side 28 (FIG. 6) opposite of the free-rise side 26.

By the term “free-rise side”, it is meant that when the baked dough product 20 is prepared, there is a portion of the product 20 that is against the baking pan, which corresponds to the bottom side 28, and the portion that is remote from the bottom of the baking pan allowed to rise; it is the portion that is allowed to rise that corresponds to the free-rise side 26.

The baked dough food product 20 includes a free first end 31 and an opposite free second end 32. The free-rise side 26 and the bottom side 28 extend between the first and second ends 31, 32. The body 24 has a thickness between the free-rise side 26 and the bottom side 28. This thickness is typically about 1.5-2 inches. While there is some variation in the thickness of the body 24 as it extends between the first end 31 and the second end 32, comparing the thinnest portion to the thickest portion will vary by not greater than 25% between the thinnest portion and the thickest portion. Other variations are possible.

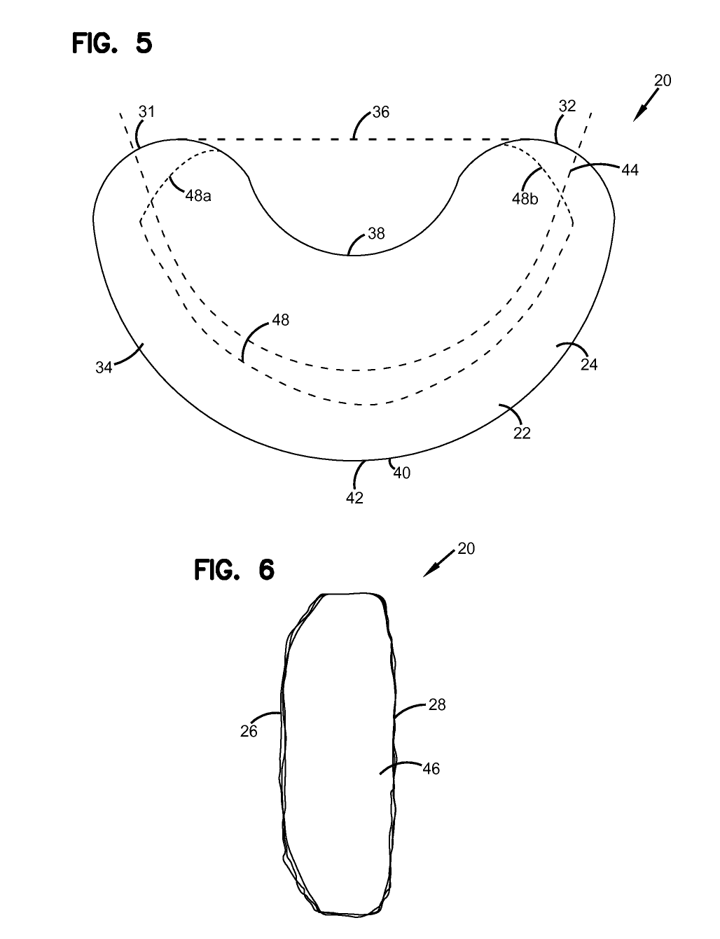

As can be seen in FIGS. 1 and 5, the body 24 is nonlinear between the first and second ends 31, 32. The body 24 is also non-overlapping with respect to itself between the first and second ends 31, 32. By the term “non-overlapping” it is meant that the body 24 does not form any intersections with itself to define any open holes or pockets, such as a pretzel, or a donut, or a bagel. Also, by the term “non-overlapping” it is meant that the dough is not coiled against itself into a rolled or coiled construction, such as a croissant. As such, the body 24 is non-ring shaped, non-pretzel shaped, non-rolled, non-coiled, and non-croissant shape. Rather, as can be seen in FIGS. 1 and 5, the body 24 forms an arcuate or curved construction 34.

The curved construction 34 may be on a single circular radius; alternatively, it may be a series of linear, non-regular lines, or radii. In one example, the curved construction 34 results in a construction in which a single straight line is able to extend between the first and second ends 31, 32 without also intersecting a portion of the body 24. One example of such a straight line is shown in FIG. 5 at 36. The line 36 is able to connect to portions of the first and second ends 31, 32 without also intersecting any other portion of the body 24. By way of contrast, if the curved construction were “S” shaped, a straight line would not be able to extend between the first and second ends without also intersecting a portion of the body 24. In one example, the curved construction 34 may be described as banana shaped. Other shapes are contemplated.

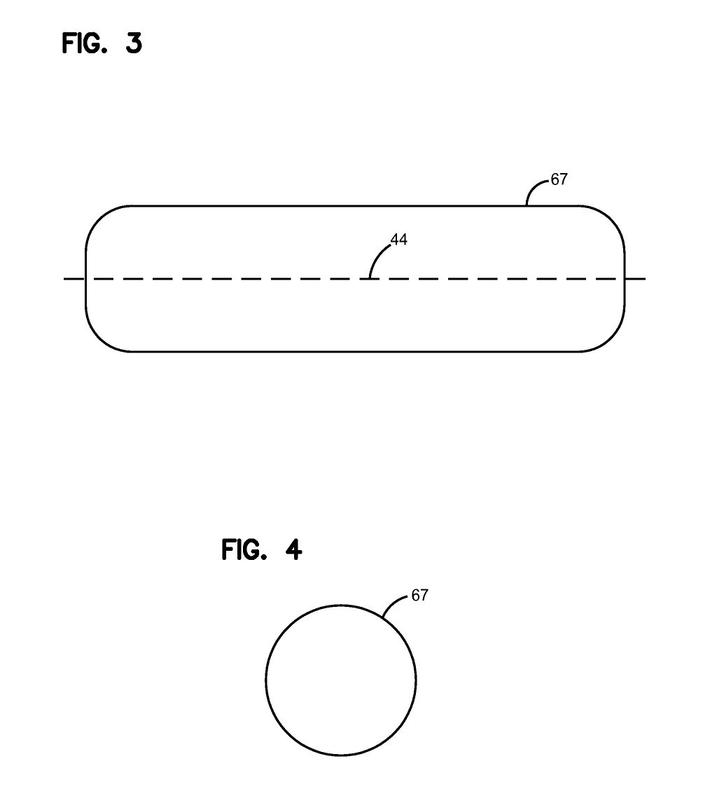

In the embodiment shown in FIGS. 1 and 3, the curved construction 34 includes an interior curve 38 and an exterior curve 40. The terms “interior” and “exterior” are used because if the baked dough product 20 were made into a ring shape, the interior curve 38 would form the interior of the ring, while the exterior curve 40 would form the exterior of the ring.

The curved construction 34 is curved such that the first and second ends 31, 32 are remote from a furthest extension 42 of the exterior curve 40. In one non-limiting example, the furthest extension 42 can correspond to an “apex section” of the exterior curve 40. By the term “apex section” it does not mean that 42 must come to a sharp point; rather, it is the portion of the exterior curve 40 in which the curve starts to move in a direction opposite from a direction it is pointing on the other side of the apex section. In one non-limiting example, the first and second ends 31, 32 are spaced about the same distance (+/−within 5%) of the furthest extension 42. It should be understood that due to baking conditions, the resulting bun 22 can have variety of shapes and sizes and may not be symmetrical.

In FIG. 5, the curved construction 34 is depicted as having a longitudinal axis 44. This longitudinal axis 44, in FIG. 5 is curved on a radius of between about 1.5-3 inches. The curved construction 34 will typically be the resulting product after baking. It is not cut into the curved construction shape 34 after baking; that is, an overlapping body such as a ring shape is not first formed and then cut into the shape of FIGS. 1 and 5.

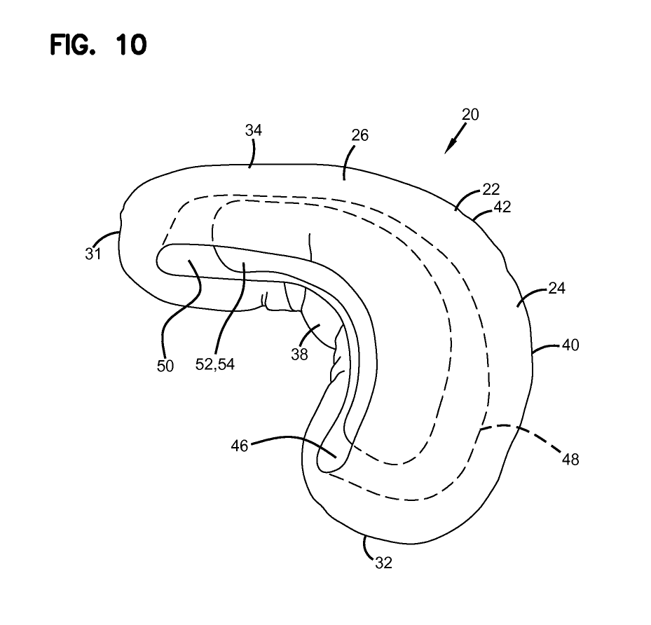

The resulting bun 22 can be sliced to form an opening and access an interior 46 of the body 24. A variety of ways to slice the bun 22 are possible. For example, the bun 22 could be sliced along the interior curve 38 passing through each of the first and second ends to allow the bun 22 to open almost flat, with only a small hinge section of body 24 in the area of the furthest extension 42. Another example can include cutting completely through the body 24 to completely separate the free-rise side 26 from the bottom side 28. Another example can include cutting along the exterior curve 40. One non-limiting example of a usable cut or slice line is shown in FIG. 5 at 48. In FIG. 5, the slice line 48 does not extend through the first end 31 or the second end 32. Rather, the slice line 48 follows the curved shape of the curved construction 34 and extends through the interior curve 38 and into the free-rise side 26 but not completely through to the exterior curve 40. This slice line 48 forms an opening 50 (FIG. 10) for accommodating food 52. The food 52 can be a sausage product 54, as defined above, such as a hot dog or a bratwurst having a curved shape, and can also include various toppings, if desired.

As can be seen in FIG. 10, the sausage product 54 is accommodated within the opening 50 to be in the interior 46 of the bun 22. The sausage product 54 preferably has a second curved shape that is curved on a radius within +/−10% of the radius of the first curved shape of the curved construction 34. In another embodiment, the second curved shape is curved on a radius within +/−20% of the radius of the first curved shape of the curved construction 34. The opening 50 can accommodate toppings for the sausage product 54, such as mustard, ketchup, sauerkraut, relish, chili, cheese, pickles, onion, etc.

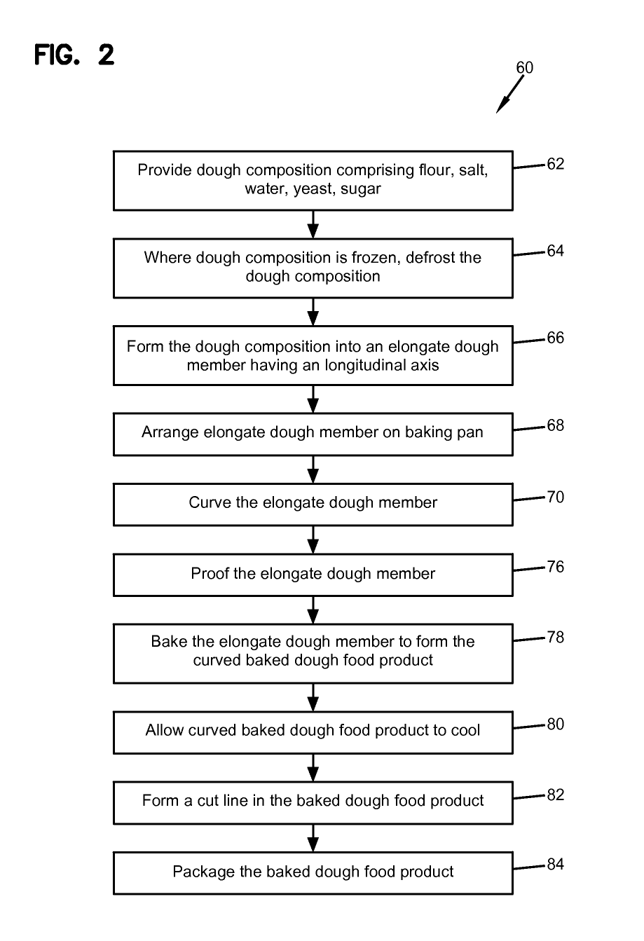

One example of a method of making the baked dough food product 20 of FIG. 1 is outlined in the method 60 of FIG. 2. First, there is a step 62 of providing a dough composition comprising flour, salt, water, yeast, and sugar. The dough composition could be many different types of dough sufficient to be usable as a bun. This could include rye, sourdough, whole wheat, white, wild rice, pumpernickel, and potato dough, for example. In one usable example, the portion of flour, salt, water, yeast, and sugar is as follows: 60% flour, 35.5% water, 2.8% yeast, and 1.7% salt. Some embodiments further include stabilizers or conditioners. Some embodiments include one or more of milk powder and sugar. There can be variations, depending upon taste and desired consistency.

Next, at step 64, if the dough composition is frozen, the composition is defrosted. In some embodiments, the dough composition is not frozen, and step 64 is not needed. Typically, a frozen dough composition in a tube shape takes about one hour to defrost to be brought to a temperature of about 78° F.

Next, at step 66, the dough composition is formed into an elongate dough member 67 (FIG. 3) having longitudinal axis 44. Typically, the dough will be at a length of about 5-6 inches long and rolled out to have a length of about 8 inches long. The diameter, at starting, of the dough member 67 is about 1.5 inches and after rolling the dough out to about 8 inches long, the diameter is smaller at about 1 inch. The dough member 67 can be rolled in cornmeal to add flavor and to prevent sticking to the pan. FIG. 4 shows an end view of the dough member 67 after the completion of step 66.

Next, at step 68, the elongate dough member 67 is arranged on a baking pan 69 (FIG. 7). For example, in one embodiment, sixteen dough members 67 are put onto the pan 69 in two rows of eight. Of course, other variations can be used.

Next, at step 70, the elongate dough member 67 is curved. As discussed above, the dough member 67 is curved to form a non-overlapping curved construction 34 between opposite first and second ends 31, 32 and so that a straight line is able to extend between the first and second ends 31, 32 without intersecting the rest of the body 24 or dough member 67. In the embodiment of FIG. 7, in one example, a plurality of the dough members 67 are arranged on the baking pan 69 in a nested fashion. By “nested”, it is meant that for each dough body 24, at least one of its respective first and second ends 31, 32 is located within the interior curve 38 of another of the dough member 67. Of course, other arrangements of the dough members 67 on the pan 69 could be used.

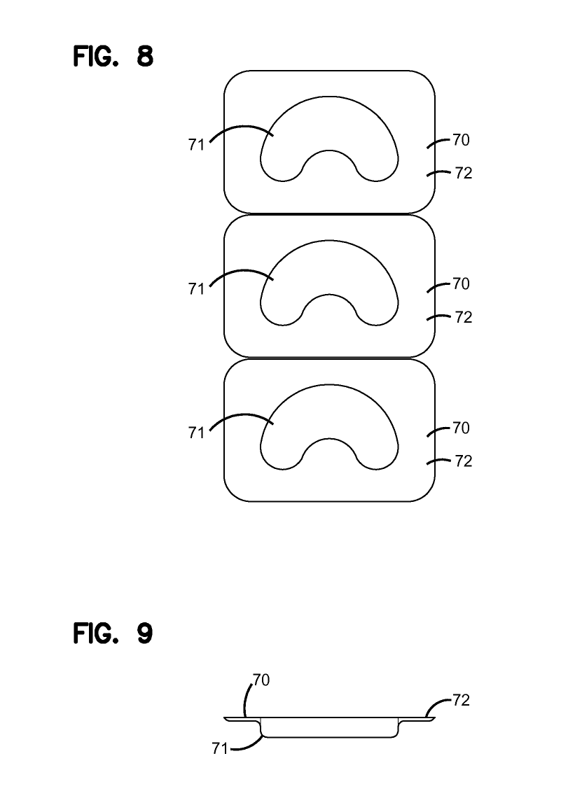

In another example embodiment, shown in FIGS. 8 and 9, a recessed pan 70 is used. FIG. 8 shows three recessed pans 70. Each of the recessed pans 70 has a baking portion 71 recessed relative to an edge 72. The recessed baking portion 71 is shaped in the form of the curved construction 34 and accommodates the dough member 67. The baking portion 71 can be a mesh weave that is stamped or inserted within the outer edges 72.

After the step 70 of curving, the curved dough members 67 may optionally be frozen for storage. If frozen, the dough members 67 would be thawed before the next step 76 of proofing.

In reference again to FIG. 2, the step 76 of proofing the elongate dough member 67 is conducted. Proofing, such as rising, may take place in a steam box at about 100° F. and 85% relative humidity for about 60 minutes. The steam box can have a size of about 26×30×26 inches. Upon proofing, the thickness between the free-rise side 26 and the bottom side 28 increases from 10% to 120% of the diameter after rolling. Variations in the temperature, relative humidity, and time can be made, depending upon the intended result.

After the step of proofing, the step 78 of baking the elongate dough member 67 is done. The elongate dough member 67 is baked to form the curved baked dough food product 20. This can be done by placing the proofed dough member in an oven of about 370° for about 12 minutes. This can vary, depending upon intended results and elevation. For example, the oven can have a temperature of between 350 and 400°, and the baking can be done between 9-15 minutes. The result is a relatively uniform thickness between the free-rise side 26 and the bottom side 28 across the length from the first end 31 to the second end 32. During the baking process, the dough member 67 shortens and loses some of its curve.

At step 80, after baking, the curved baked dough food product 20 is allowed to cool. In one usable example, after about 20-30 minutes, the product 20 can be handled for packaging. In many embodiments, the next step is packaging the baked dough food product at step 84. In some embodiments, before the step of packaging, there may be a step 82 of forming a cut line or a slice line in the baked dough food product 20. The slice line is optional, and it is believed to keep the buns 22 fresher when no slice line is added. During the step 84 of packaging, in one embodiment, five buns are packaged together in one package, so that it matches a standard package containing 5 bratwurst.

There is further a method of making a food product including providing the bun 22 having a first curved shape between the opposite first and second ends 31, 32, with a straight line being able to extend between the first and second ends without intersecting the bun 22. There is a step of slicing the bun 22 to provide opening 50 to access an interior 46 of the bun 22 between the free-rise side 26 and the bottom side 28. Next, a sausage product having a second curved shape is oriented through the opening 50 and into the interior 46 of the bun 22. In general, the second curved shape is within +/−10-20% of the radius of the first curved shape of the bun 22.

The above represents example principals. Many embodiments can be made and practiced using these principals.

We claim:

1. A baked dough food product comprising:
(a) a body have a free-rise side and a bottom side opposite of the free-rise side;
(b) a first and a second opposite end; the free-rise side and bottom side extending between the first and second ends;
(i) the body being nonlinear and non-overlapping between the first and second ends to form a curved construction; and
(ii) a straight line being able to extend between the first and second ends without intersecting the body.

2. A baked dough food product according to claim 1 wherein:
(a) the body having a thickness between the free-rise side and bottom side of about 1.5-2 inches.

3. A baked dough food product according to claim 1 wherein:
(a) the curved construction is on a radius of about 1.5-3 inches.

4. A baked dough food product according to claim 1 wherein:
(a) the baked dough food product comprises: flour, salt, water, yeast, and sugar.

5. A baked dough food product according to claim 1 wherein:
(a) the product comprises a bun.

6. A baked dough food product according to claim 5 further comprising:
(a) a cut line in the body of a size sufficient to allow for insertion of a sausage in the bun between the free-rise side and the bottom side.

7. A baked dough food product according to claim 6 further comprising:
(a) a sausage in the bun between the free-rise side and the bottom side; the sausage being a curved shape.

8. A baked dough food product according to claim 7 wherein:
(a) the sausage includes any one of a hotdog or bratwurst in a natural casing.

9. A baked dough food product according to claim 7 wherein:
(a) the curved construction is on a radius of about 1.5-3 inches; and
(b) the sausage is on a radius within +/−10% of the radius of the curved construction.

10. A method of making a baked dough food product, the method comprising the steps of:
(a) providing a dough composition comprising flour, salt, water, yeast, and sugar;
(b) forming, from the dough composition, an elongate dough body having a longitudinal axis with opposite first and second ends;
(c) arranging the dough body on a baking pan;
(d) curving the dough body to form a non-overlapping curved construction between the first and second ends and so that a straight line is able to extend between the first and second ends without intersecting the body;
(e) proofing the dough body; and
(f) baking the dough body to form a baked dough food product.

11. A method according to claim 10 wherein:
(a) the step of curving the body includes curving the dough body on a radius of about 1.5-3 inches.

12. A method according to claim 10 wherein:
(a) the step of baking includes putting the dough body in an oven having a temperature of between 350° and 400° for 9-15 minutes.

13. A method according to claim 10 wherein:
(a) the step of arranging the dough body on a baking pan includes arranging a plurality of dough bodies on the baking pan;
(i) each of the dough bodies being shaped into the curved construction; each of the dough bodies having an interior curve and an exterior curve between opposite first and second ends; and
(ii) the plurality of dough bodies being arranged on the baking pan nested so that for each dough body, at least one of the respective first and second ends is within the interior curve of another of the dough bodies.

14. A method of making a food product; the method comprising:
(a) providing a bun having a first curved shape between opposite first and second ends; a straight line being able to extend between the first and second ends without intersecting the bun; the bun having a free-rise side and a bottom side;
(b) slicing the bun to provide an opening to access an interior of the bun between the free-rise side and the bottom side; and
(c) orienting a sausage product having a second curved shape through the opening and into the interior of the bun.

15. A method according to claim 14 wherein:
(a) the first curved shape is on a radius of 1.5-3 inches; and
(b) the step of orienting a sausage product includes orienting a sausage product having a second curved shape that is within 10% of the radius of the first curved shape.
